(19) United States
(12) Patent Application Publication
(10) Pub. No.: US 2005/0080578 A1
(43) Pub. Date: Apr. 14, 2005

(54) Mass spectrometry spectral correction

(76) Inventor: Matthew S. Klee, Wilmington, DE (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/682,725

(22) Filed: Oct. 10, 2003

(51) Int. Cl. G06F 19/00

(52) U.S. Cl. 702/85

(57) ABSTRACT

System and method for correcting spectral skew in a mass spectrometer by optimizing the mass spectrometer for a mass spectrometry performance parameter, generating measured spectra of a known reference compound, comparing the measured spectra to the known spectra of the known reference compound, generating a correction function from the comparison, and using the correction function to correct subsequent scans on the mass spectrometer. The present invention involves the use of a software correction of spectra (signal processing) to match any reference mass spectral response paradigm (e.g., magnetic sector instruments). By applying a software correction, the performance of the mass spectrometer may then be optimized independently, thereby yielding better overall performance of the system.

### TECHNICAL FIELD OF THE INVENTION

The present invention relates to mass spectrometry, and more particularly to improvements in corrections of skew in mass spectrometry.

### BACKGROUND

Quadrupole mass spectrometers are known. An illustration of a mass spectrometer is shown in FIG. 1. A compound, usually from a gas chromatograph, is introduced in a neutral state to the mass spectrometer where it is then ionized. The compound may be ionized by chemical ionization or by electron impact, depending upon the type of information sought. Generally, the ions are accelerated into a quadrupole mass filter, generally designated by the reference numeral 100, which includes a quadrilaterally symmetric parallel array of four identical rods 110.

To obtain an indication of the mass spectrum of the ions, a constant DC and superimposed sinusoidally-modulated voltage is applied to the rods of the quadrupole mass filter, and are scanned in tandem such that their ratio remains constant. More specifically, each diametrically opposite pair of rods are connected together. A signal, which includes a positive DC component and a radio frequency (RF) component, is applied to one pair of rods, while an opposite signal, which includes a negative DC component and a radio frequency (RF) component opposite in phase to the RF component of the first mentioned signal, is applied to other pair of rods. The DC and RF component signals are scanned such that their ratio of amplitudes is kept constant. The fraction of the total ion current that exits the quadrupole mass filter is partitioned according to the mass-to-charge ratio of each ion of the ion current. By scanning the RF and DC voltage components from a low to a high value, a plurality of ions, each having a particular mass-to-charge ratio and arriving simultaneously at the entrance to the quadrupole mass filter, will arrive sequentially and ordered at the exit of the quadrupole mass filter according to mass-to-charge ratio. By scanning the RF and DC voltage components from a low to a high value, ions having a relatively low mass-to-charge ratio will arrive at the end of the quadrupole mass filter before ions having a relatively high mass-to-charge ratio. The ion current exiting the filter is sensed by a detector, such as a Faraday cup 130.

The location and intensity of discrete signals measured for each mass-to-charge ratios across the mass range of interest in a given scan comprises a mass spectrum. The specific mass of each ions and its intensity relative to other ions in the spectrum are unique to the compound being analyzed. In this way, mass spectra correspond to molecular fingerprints. To identify an unknown in a sample, one compares its mass spectrum to those in a reference library of known spectra 150. There exist large libraries that include many decades' worth of identified compounds, mostly using old mass spectrometers of limited range, linearity, etc., and often based on a separation principle different than quadrupole mass spectrometry.

The quadrupole mass filter only allows a narrow range of ions having a specified mass-to-charge ratio, m/e, to pass through at any given time. Thus, the quadrupole is directly analogous to the monochromator in other spectroscopic techniques. Consequently, quadrupole mass spectrometers are scanning instruments. To generate a single complete mass spectrum, they monitor ions of one m/e for a brief period of time, record the intensity, move on to the next m/e value, and repeat the entire process over and over for every possible ion in range of the instrument. Depending on the range of m/e ratios scanned and the speed and quality of the acquisition, a typical quadrupole mass analyzer may require 0.1-10 sec to construct a single mass spectrum (i.e., spectra being created at a rate of 0.1-10 Hz).

The historical mass spectral reference libraries are comprised of spectra with skews specific to whatever instrument on which they were generated. A large number of spectra of organic compounds, for example, was generated using magnetic sector instruments. The characteristic skew associated with sector instruments then became the reference standard. Since compounds are identified by comparing the relative intensities of peaks (corresponding to ions of a specific m/e) to those in a reference spectrum, spectra that are generated by different mechanisms (e.g., quadrapole MS, ion traps, etc.) must correspond to the sector paradigm.

To ensure that spectra that are produced from a quadrapole MS (for example) compare to those in the reference database, MS control parameters are adjusted to increase or decrease signal levels across the mass range of interest and to generate spectra that are searchable against the historical database. The adjustment yields searchable spectra, but all skew in the spectra can not be corrected perfectly in this manner.

### SUMMARY

The present invention is directed to a system and method for correcting spectral skew in a mass spectrometer by optimizing the mass spectrometer for a mass spectrometry performance parameter, generating measured spectra of a known reference compound, comparing the measured spectra to the known spectra of the known reference compound, generating a correction function from the comparison, and using the correction function to correct subsequent scans on the mass spectrometer. The present invention involves the use of a software correction of spectra (signal processing) to match any reference mass spectral response paradigm (e.g., magnetic sector instruments). By applying a software correction, the performance of the mass spectrometer may then be optimized independently, thereby yielding better overall performance of the system.

### DESCRIPTION OF THE DRAWINGS

The features, aspects, and advantages of the present invention will become better understood with regard to the following description, appended claims, and accompanying drawings where:

FIG. 1 depicts a known mass spectrometer;

FIG. 2 depicts a mass spectrometer according to an embodiment of the present invention;

FIG. 3 depicts a flowchart showing the operation of an embodiment of the present invention;

FIG. 4 depicts a graph showing mass-to-charge ratio versus signal for a reference and measured compound; and

FIG. 5 depicts a graph showing corrected mass-to-charge ratio versus signal.

### DETAILED DESCRIPTION

Mass spectrometer physical design and electronic control parameters are adjusted so that the resulting mass spectral response matches that of some external reference. The electronic tune parameters are typically adjusted via a tune process (manual or automated). A common goal of such tuning is matching the relative intensities of specific ions within a desired range of masses to some reference. In fact, some methods prescribe that specific target ion intensities must be met (target tunes) as part of establishing compliance.

By adjusting tune parameters to meet the goal of matching ion ratios, one does not necessarily meet other desirable goals such as maximum signal or signal-to-noise ratio. Since one of the main purposes of mass spectrometry is to confirm identity of analytes by comparing the resulting mass spectra to established reference spectra, other performance goals take lower priority.

The best way to achieve multiple optimization goals is to decouple them. By offloading spectral skew correction to the signal processing stage, the mass spectral parameters can be tuned for another purpose, such as optimal signal-to-noise ratio, as is described in more detail in related application Ser. No. ______, concurrently filed, entitled “Signal Enhancement,” which is incorporated by reference herein.

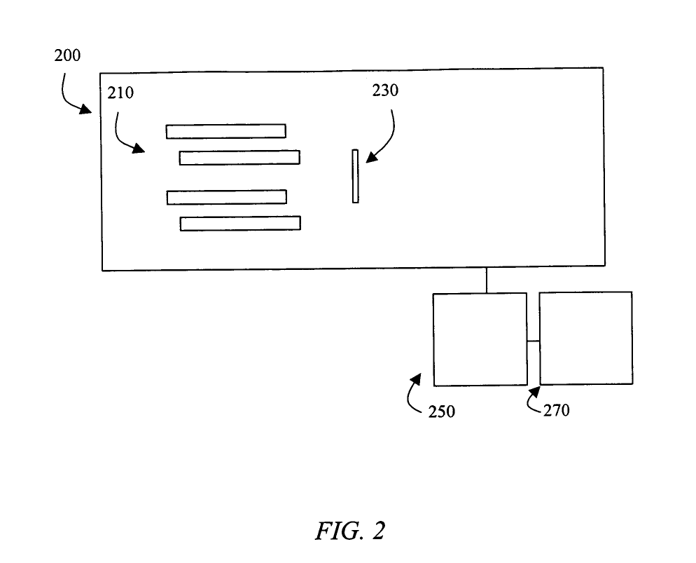

With respect now to FIG. 2, there is shown a mass spectrometer according to an aspect of the present invention. The mass spectrometer is generally designated by the reference numeral 200, and will be described in more detail below.

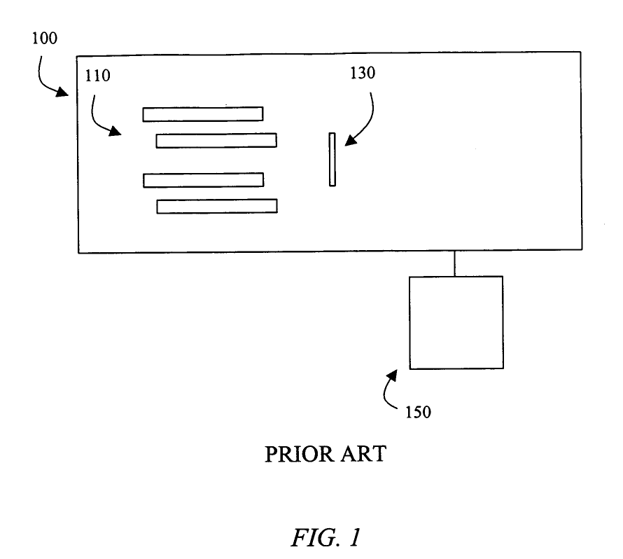

As described with reference to the mass spectrometer 100 of FIG. 1, the mass spectrometer 200 of FIG. 2 has four symmetrical rods 210 through which an ion is accelerated, and a detector 230, which may be a Faraday cup, that receives the ions. The mass spectrometer 200 is controlled by various control parameters. Mass spectrometer control parameters include (but are not limited to) emission current, electron energy, repeller voltage, ion focus voltage, detector gain, mass axis gain and offset, peak width gain and offset, magnetic field shape and strength.

Prior to comparing the acquired mass spectra to entries in a reference library 270, the spectral skew is corrected in a skew control 250. The skew control 250 may be combined with other signal processing functions on the mass spectrometer 200, or may be separate. The operation of the skew control 250 is described in more detail below.

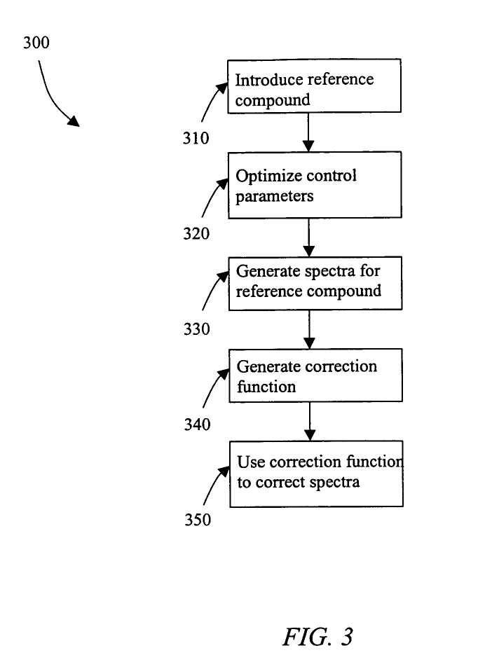

With reference now to FIG. 3 of the Drawings, there is shown therein a flowchart, depicting a method of performing the present invention. The process is generally designated by the reference numeral 300, and will be described in more detail below.

Initially, a reference compound or compounds would be introduced to the mass spectrometer (step 310). This reference compound would be a compound with a known spectrum of ions at specific m/e and specific relative intensities. Next, the control parameters for the highest performance in a single category or multiple categories of interest, e.g., S/N, resolution, ion stability, etc., would be optimized (step 320). Then, a spectrum would be generated of the reference compound, with particular skew specific to that instrument (step 330). After generating the spectrum, the measured ion ratios are compared to the known external references and a correction function is generated (step 340). Finally, this correction function can be used to correct all subsequent spectra generated by the particular instrument (step 350). The comparison and generation of a correction function may be performed within the mass spectrometer or separately, and may be performed immediately following the acquisition of the spectra, or may be performed at a later time.

Appropriate correction algorithms include (but are not limited to) standard curve fitting algorithms, e.g., polynomial regression, linear regression, exponential regression, logarithmic regression, iterative deviation minimization algorithms, etc.

The reference compound is a compound with a known spectrum of ions at specific m/e and specific relative intensities, and may be separate from any subsequent analyzed compounds, or may be added to an analyzed compound, or may be a native component of an analyzed compound. If the reference compound exists naturally within or has been added to the analyzed compound, then the correction function may be generated after acquiring one mass spectrum, and then may applied to the acquired spectrum. Also, if the reference compound is contained within the analyzed compound, then a correction function may be generated upon every scan, allowing the generated correction function to be corrected for any changes in the spectral skew of the instrument over time.

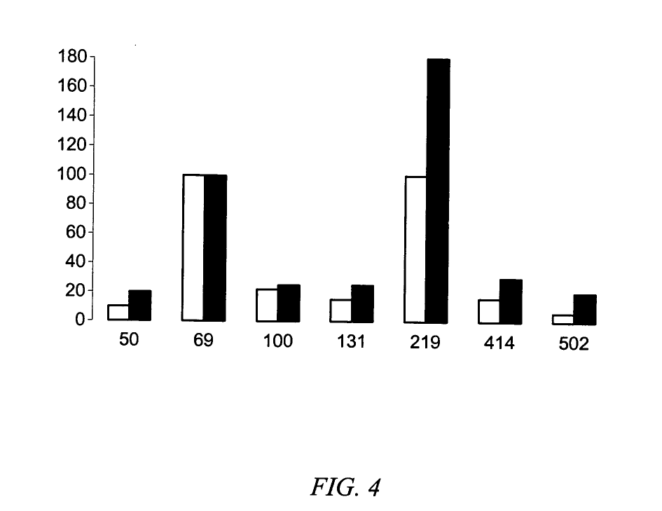

With respect now to FIG. 4, there is illustrated therein the spectrum for a mass spectrometer tuning compound (PFTBA) on a hypothetical instrument, such as the device shown in FIG. 2, run under maximum performance conditions. Compared to historical target values, many of the ions have higher response because the spectrometer was tuned to maximize an analytical performance metric like signal-to-noise, sensitivity, linearity, and/or reproducibility. As is typical for presentation of mass spectral data, m/e is on the x-axis and abundance is on the y-axis. In the graph, the white bars are the reference spectra and the black bars are the measured spectra. As shown in FIG. 4, there are distinct differences in the relative intensities of discrete ions, especially around m/e of 229 amu. This difference in relative intensities would lead to a poor confidence in matching to reference spectra, and an increased potential for misidentification.

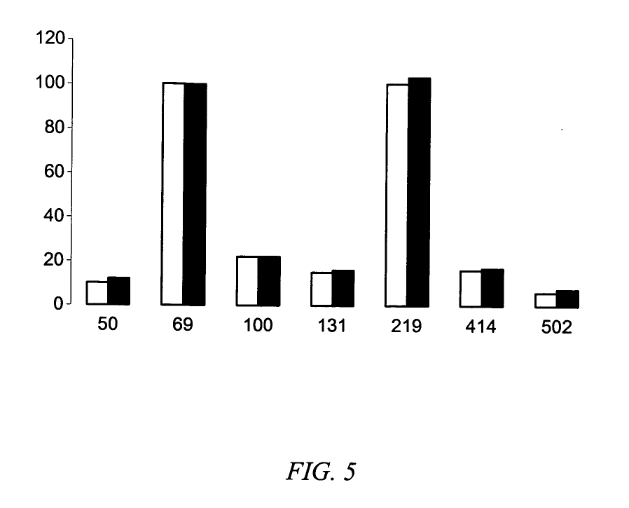

FIG. 5 illustrates the results of applying algorithmic correction to the data, to better match the actual ratios to historical reference values. Once the algorithm yielding best match to target values across the mass range of interest is determined, it is applied to subsequently acquired mass spectra, either as part of the real-time data processing steps, or subsequently in a reprocessing step. In this graph, m/e is on the x-axis and abundance is on the y-axis, and the white bars and black bars represent the reference spectra and the measured spectra, respectively.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

1. A method for correcting spectral skew in a mass spectrometer, said method comprising:
optimizing said mass spectrometer based on a mass spectrometry performance metric;
acquiring one or more measured mass spectra of a known reference compound;
comparing said measured spectra to the one or more known spectra of said known reference compound;
generating a correction function from the comparison;
acquiring subsequent spectra of an analyzed sample; and
correcting, using said correction function, subsequent spectra acquired on said mass spectrometer.

2. The method according to claim 1, wherein said mass spectrometry performance metric is selected from the group consisting of signal-to-noise ratio, resolution, ion stability, mass range, peak width, repeatability, accuracy, signal intensity, sensitivity, linearity, and reproducibility.

3. The method according to claim 1, wherein said correction function is generated using a mathematical curve fitting algorithm.

4. The method according to claim 3, wherein said mathematical curve fitting algorithm is selected from the group consisting of polynomial regression, linear regression, exponential regression, logarithmic regression, and iterative deviation minimization algorithm.

5. The method according to claim 1, wherein the step of generating a correction function is done separate physically from the step of generating one or more measured mass spectra.

6. The method according to claim 1, wherein the step of generating a correction function is done separate temporally from the step of generating one or more measured mass spectra.

7. The method according to claim 1, wherein the known reference compound is contained within the analyzed sample, and the correction function is generated for every run, thereby allowing the correction function to be checked and corrected to compensate for any changes in spectral skew of the instrument over time.

8. The method according to claim 1, wherein the known reference compound is an identifiable component native to the analyzed sample, whereby the one or more measured mass spectra can be compared to the one or more known spectra and the correction function can be generated.

9. The method according to claim 1, wherein the reference compound is present in ubiquitous fashion.

10. A mass spectrometer system comprising:
means for optimizing a mass spectrometer based on a mass spectrometry performance metric;
means for acquiring mass spectral data;
means for comparing the measured mass spectral data to a reference mass spectral data; and
means to correct the measured mass spectral data based on the comparison.

11. The mass spectrometer of claim 10, wherein said means for acquiring mass spectral data is a quadrupole mass spectrometer.

12. The mass spectrometer according to claim 10, wherein said means to correct the measured mass-to-charge ratio uses a mathematical curve fitting algorithm.

13. The mass spectrometer system according to claim 12, wherein said mathematical curve fitting algorithm is selected from the group consisting of polynomial regression, linear regression, exponential regression, logarithmic regression, and iterative deviation minimization algorithm.

14. The mass spectrometer system according to claim 10, wherein the means for comparing and means for correcting is separate physically from the means for acquiring mass spectral data.

15. The mass spectrometer system according to claim 10, wherein the means for comparing and means for correcting is separate temporally from the means for acquiring mass spectral data.
